(19) United States
(12) Patent Application Publication
(10) Pub. No.: US 2019/0087111 A1
(43) Pub. Date: Mar. 21, 2019

(54) COMMON LOGICAL BLOCK ADDRESSING TRANSLATION LAYER FOR A STORAGE ARRAY

(71) Applicant: Seagate Technology LLC, Cupertino, CA (US)

(72) Inventor: Chetan Bendakaluru Lingarajappa, Bangalore (IN)

(21) Appl. No.: 15/705,835

(22) Filed: Sep. 15, 2017

(51) Int. Cl. G06F 3/06

(52) U.S. Cl. CPC G06F 3/0631; G06F 3/0689; G06F 2003/0697; G06F 3/0667; G06F 3/0604

(57) ABSTRACT

A method of managing data in a redundant array of independent disks (RAID) system includes receiving data and allocating a first storage space on a first storage medium at a data management layer based on received data. The method also includes instantiating a data translation layer based on the data management layer configured to communicate with a data protection layer. The method also includes translating the received data from the first storage space on the first storage medium using the data translation layer to a second storage space on a second storage medium and transmitting the data.

### BACKGROUND

The present disclosure relates to data management structures, and relates more particularly to using a common translation layer in a storage array. Even more particularly, this case is directed to an indexed logical block addressing (LBA) data management structure for an enterprise storage environment in which a data management layer (DML) and a data protection layer (DPL) have different LBA striping granularities.

A redundant array of independent disks (RAID) storage system setup can utilize a number of physical disks in a physical disk layer (PDL). Importantly, RAID can have benefits that are either advantageous to disk performance (read/write access time and/or throughput), data integrity (mirroring data in case of fault), or both. A PDL can be configured to communicate with other physical disks by way of intermediary, virtual disks in a virtual disk layer (VDL). VDLs can be structured in various ways, including using various block “striping” techniques, prior to writing to blocks through a PDL in a RAID-type configuration.

### SUMMARY

According to the present invention, a new translation layer created and situated between the DML and DPL, using a coded striping technique with storage parity efficiently coded to be compatible with both the applicable DML and DPL. This can beneficially increase efficiency, speed, and simplicity when compared to existing art.

In a first aspect of the present disclosure, a method of managing data in a redundant array of independent disks (RAID) system includes receiving data. The method also includes allocating a first storage space on a first storage medium at a data management layer based on received data. The method also includes instantiating a data translation layer based on the data management layer, the data translation layer configured to communicate with a data protection layer. The method also includes translating the received data from the first storage space on the first storage medium using the data translation layer to a second storage space on a second storage medium. The method also includes transmitting the data.

In a second aspect of the present disclosure, a data management system includes a processor operatively connected to a memory and the data management system configured to perform steps including receiving data. The data management system is also configured to perform the step of allocating a first storage space on a first storage medium at a data management layer based on received data. The data management system is also configured to perform the step of instantiating a data translation layer based on the data management layer, the data translation layer configured to communicate with a data protection layer. The data management system is also configured to perform the step of translating the received data from the first storage space on the first storage medium using the data translation layer to a second storage space on a second storage medium. The data management system is also configured to perform the step of transmitting the data.

In a third aspect of the present disclosure, a computer program product for managing data in a redundant array of independent disks (RAID) system includes a computer-readable storage device having a computer-readable program stored therein, where the computer-readable program, when executed on a computing device, causes the computing device to receive data. The computer-readable program, when executed on the computing device, also causes the computing device to allocate a first storage space on a first storage medium at a data management layer based on received data. The computer-readable program, when executed on the computing device, also causes the computing device to instantiate a data translation layer based on the data management layer, the data translation layer configured to communicate with a data protection layer. The computer-readable program, when executed on the computing device, also causes the computing device to translate the received data from the first storage space on the first storage medium using the data translation layer to a second storage space on a second storage medium. The computer-readable program, when executed on the computing device, also causes the computing device to transmit the data.

These and various other features and advantages will be apparent from a reading of the following detailed description.

### BRIEF DESCRIPTION OF THE DRAWINGS

Other important objects and advantages of the present invention will be apparent from the following detailed description of the invention taken in connection with the accompanying drawings.

FIG. 1 is a block diagram of a storage system having five drives and the drives having four stripes, according to various embodiments.

FIG. 2 is a block diagram of a storage system having eight drives having four stripes, according to various embodiments.

FIG. 3 is an example translation table for FIG. 1 and FIG. 2 provisioned with RAID 5 data protection, according to various embodiments.

FIG. 4 is a translation table for FIG. 1 and FIG. 2 provisioned with RAID 6 data protection, according to various embodiments.

FIG. 5 is a flowchart for a method according to the present invention, according to various embodiments.

FIG. 6 is a block schematic diagram of a computer system according to embodiments of the present disclosure.

### DETAILED DESCRIPTION

The present disclosure relates to data management structures, and relates more particularly to an indexed logical block addressing (LBA) data management structure for an enterprise storage environment in which a data management layer (DML) and a data protection layer (DPL) of a host and disk have different LBA striping granularities.

As used herein, various terms are defined as follows:

Host side and disk side: for the purposes of this disclosure, “host side” refers to a host as defined in contrast to a disk, as in “disk side.” In a network a host can be a device, such as a hard-disk drive (HDD) or an HDD controller, that has established a connection to a network an internet protocol (IP) address. For disk side, an operation can occur at an actual disk drive instead of at the network host level, and the disk may not be assigned a unique IP address.

Stripe: a stripe as used in disk striping is employed in a process of dividing a body of data into blocks and spreading the data blocks across multiple storage devices, such as HDDs or solid-state drives (SSDs). A stripe includes data divided across the set of storage devices as a stripe, which refers to the stripe on an individual storage device. RAID 0 is another term for disk striping. Disk striping can be used without employing a RAID in some cases.

Redundant array of independent disks (RAID): RAID uses disk striping to distribute and store data across multiple physical drives in a non-parity, non-fault-tolerant manner, in basic RAID 0 (striping) form. Disk striping with RAID can produce redundancy and reliability. For instance, RAID 4 (single) and RAID 5 (double) can use parity blocks to protect against a disk failure, and RAID 4 and 5 can be combined with RAID 0 to give a combination of speed of access and redundancy of data storage. RAID 6 can utilize two drives for parity and can protect against two simultaneous drive failures. RAID 1 can refer to simple data mirroring, where data is fully copied from one disk to another to give redundancy and access at the expense of having twice the physical drives per amount of usable data storage. Other RAID schemes can be employed, and are known in the art.

Layer: a layer, or translation layer, is a layer of a software or systems construct that is used to convert one set of code to another. A translation layer can have a particular “granularity,” and two layers can communicate more efficiently if they have the same granularity. By extension, layers may communicate less efficiently with each other if they have different granularity.

Logical block addressing (LBA): LBA is a scheme used to specify the location of blocks of stored data on a storage device. LBA is also a linear addressing scheme, and LBA blocks can be located by an integer index, numbered as LBA (block) 0, 1, 2, etc. LBA data blocks can be referred to as LBAs, herein. In addition, LBAs can also represent individual strips of data stripes, herein. LBA can be utilized for RAID schemes, among other data management schemes.

Logical unit number (LUN): a LUN is a number used to identify a logical unit, which can be a device addressed by a small-computer system interface (SCSI) protocol or storage area network (SAN) protocol. A LUN can be used with any device that supports read/write operations, such as a logical disk created by a SAN. User LUN or LUN space can be LUN or LUN space of a particular user or multiple users.

Page: a page is a unit of memory storage that is composed of one or more memory blocks, such as LBAs. A page can be selected such that an operating system (OS) can process the entire page in one operation. Therefore, pages can vary in size from very small or very large depending on a computer configuration.

Virtual disk layer (VDL): a VDL is a layer composed of a plurality of contiguous LBAs of a virtual host LUNs.

Physical disk layer (PDL): a PDL is a layer composed of a plurality of contiguous LBAs of a physical drive. A physical disk layer, as used herein, contains only a group of physical disks that are used by a VDL to create RAID 0, RAID 5, RAID 6, RAID 5-0 or parity de-clustered RAID and to export a user-visible LUN to hosts.

Parity de-clustered RAID: parity de-clustered RAID is a RAID type that uses multiple traditional parity RAID like RAID 5 or RAID 6 (usually RAID 6), but defines each stripe by randomly selecting individual LBAs (forming a stripe) across the list of parity RAID groups. One advantage of parity de-clustered RAID can include that when any of the parity disk groups fails all the drives are involved during the reconstruction of the failed drive since the stripes are dispersed across all the parity disk groups.

The various Figures included herein illustrate mapping table organizations for each of the striped RAID group (RAID 0, RAID 5, RAID 6, RAID 5-0, and parity de-clustered RAID). In parity de-clustered RAID is all the LBAs of a particular stripe may or may not start at the same physical disk offset of physical drive for all the drives which are part of the RAID type. Whereas in RAID 0, RAID 5, RAID 6, RAID 5-0, the disk offsets for all the LBAs of a particular stripe typically start at the same physical drive offset in all the individual physical drives of a RAID disk group. For at least these reasons, different Figures are included for different individual RAID types.

Virtual LBA: a virtual LBA represents an offset within a virtual LUN (as seen by host). Each LBA can be, for example, 512 bytes in size.

Virtual block number: a virtual block number represents a virtual LBA in terms of block size where virtual block number is equivalent to a virtual LBA/block size. An example virtual LBA/block size is 4 MB. Virtual block numbers can be visible and/or accessible to user via a LUN. A user-visible <LBA, number of blocks> can translate to a virtual block (LBA/block size) that can be looked up in a mapping table to get the corresponding physical blocks.

Physical block number: a physical block number represents a physical LBA in terms of block size where physical block number is equivalent to a physical LBA/block size. An example physical LBA/block size is 4 MB.

Data page table (DPT): a DPT is a type of multi-level, sparse page table. A DPT can be similar to an operating system (OS) page table, which can be used for memory management of process address space. According to this disclosure, a DPT can be used for storage management of LUN storage space. The DPT can translate virtual block numbers to physical block numbers (and vice-versa), and the list of physical block numbers can form usable storage capacity which can then be provisioned to a host LUN.

Redundant page table (RPT): an RPT is a type of multi-level, sparse page table. System can include and utilize a single RPT for RAID 5 stripes and two RPTs for RAID 6 stripes. RPTs can be similar to an OS page table used for memory management, but can be used for storage management. This RPT can translate virtual block number to physical block number (or vice-versa), which can include a redundant storage capacity of a RAID stripe. In various embodiments, size of physical and virtual disk layers are the same.

Data management layer (DML): a DML is a type of layer that can support various data management features, such as thin provisioning, snapshots, and/or tiered schemes. At present, a host input/output (I/O) (e.g., LBA, size) can translated by a DML and sent to a separate layer for data protection, a data protection layer (DPL). A DML generally works at a host I/O layer. Such host I/O layer may not be aligned to and may be less than the stripe size.

Data protection layer (DPL): a DPL can be another layer that can include various data protection features, such as striped parity RAID, de-clustered parity RAID, etc. A DPL can translate a host I/O into RAID stripes, data, and parity blocks in order to complete the host I/O. As known, redundant array of independent disks (RAID) (as can be used for a DPL) generally is configured to work on a complete stripe, as opposed to a DML, which generally works at a host I/O layer.

In a situation where both types of RAID advantages (management and protection) are employed, various inefficiencies can result. In data communication within the storage environment, inefficiencies are common due to often sparse translation layers in performance-related (DML) RAID aspects, and full translation layers in integrity-related (DPL) RAID aspects. Sparseness of translation layers, as used herein, can include a relative number or ratio of sparse translation layer data block usage compared to capacity. Therefore, the interaction of the two layer types can cause performance detriments, including layer redundancy or multiplicity, among others.

Various existing system configurations for facilitating communication between DML and PDLs include inefficient and complex, two-step processes that are provide a linearized dynamic storage pool by abstracting and dividing physical storage devices, and a virtual linear data map is typically created. Therefore, known configurations for layer communication are complex and could benefit from increased efficiency and simplicity.

An enterprise storage array can support block input/output (I/O) protocols, which can export storage capacity as LUNs to external host systems. In these enterprise storage arrays, a number of data layers can be utilized. A first data layer can include a front-end block protocol (e.g., iSCSI, FC, SAS). Another layer can include a DML, which can support, e.g., thin provisioning, snapshots, and/or tiered schemes. Another layer can include a data protection layer (DPL), which can include, e.g., striped parity RAID, de-clustered parity RAID, etc. Yet another layer can include a back-end block protocol, such as SAS (serial attached SCSI).

At present, a host I/O (including e.g., LBA and block size) can be translated by a DML and sent to a separate DPL. The DPL can then translate the host I/O into RAID stripes, data, and parity blocks in order to complete the host I/O. As a result, there would be multiple translations and the granularity of storage space dealt by the two translation layers would also be different. As known, a RAID setup configured to be used for one or more DPL generally is configured to work on a complete stripe. In contrast, a RAID setup configured for one or more DML is generally configured to work at a host I/O layer. Such DML host I/O layer may not be aligned to and may be less than the stripe size. As a result, at present, data translation layers work at different granularity. While supporting parity de-clustered RAID-type setup, a storage array system can end up with multiple redundant translation layers. According to this disclosure, various solutions are proposed whereby a single, common translation layer is utilized for efficient communication between both DML and DPL.

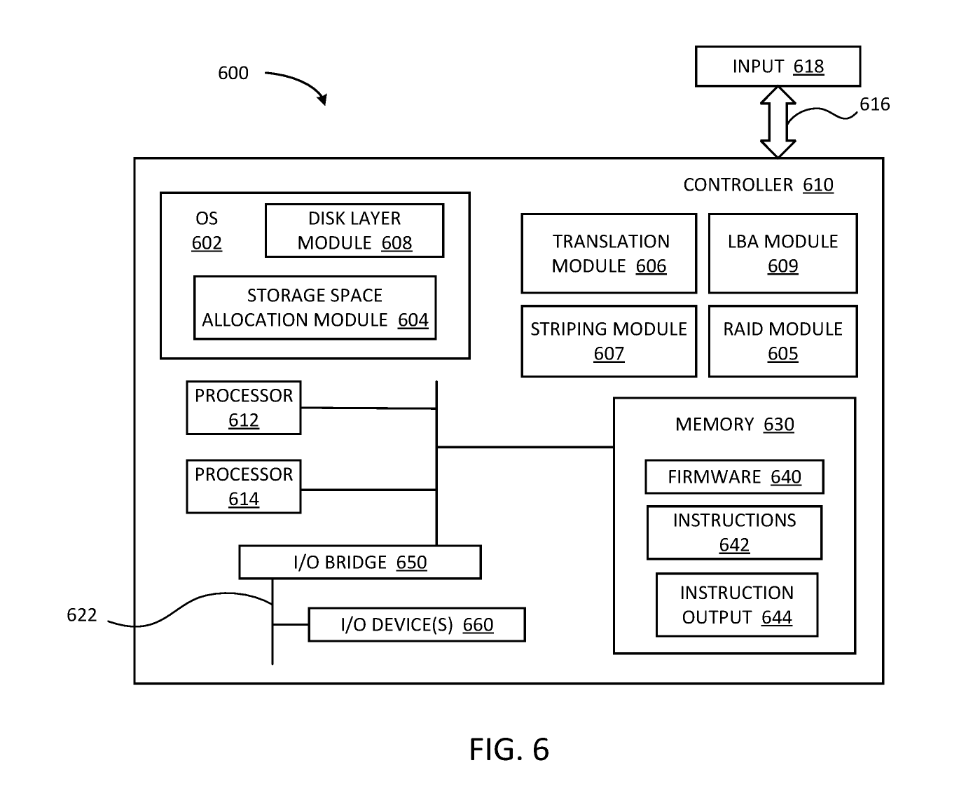

In an embodiment of an improved translation setup according to the present disclosure, a storage space allocation unit (e.g., storage space allocation module 604 of FIG. 6) can be a complete (RAID) stripe of a striped parity RAID that contains both data physical block number and redundant physical block number. In various embodiments, a complete stripe of a user data space (e.g., data physical block number) can be allocated and arranged in DPT and a redundant stripe space (e.g., redundant physical block number) in RPT. RAID stripes can be allocated and the physical block numbers are distributed such that the DPT and RPT grow in size until a complete storage capacity is represented. In some embodiments of the present disclosure, a DML can use a complete stripe for data store on a data translation layer. In other embodiments, a DML can instead use a partial stripe for data storage on a data translation layer.

In an example host LBA data block translation, a host I/O can be translated as LBA (data blocks) into a virtual block number, where block size can be much smaller than the virtual block number size (e.g., two virtual block number blocks or fewer). In the example host LBA translation, a virtual block number can be indexed into a DPT in order to get the corresponding list of RAID stripe data physical block numbers. Also in the example host LBA translation, a virtual block number percentage (e.g., a number of RAID data drives) can be indexed into RPT to get the redundant physical block number as an output. In various embodiments, once all the data and redundant physical block numbers are obtained, a striped parity RAID logic can be performed in order to get backend physical drive I/Os, including LBA, blocks, etc. In various embodiments, the above framework can support all major features of an enterprise storage array at stripe physical block number granularity.

In some cases, extra translation layers can help to control various storage array operations at a finer stripe or data granularity. For example, extra translation layers can support different RAID levels (e.g., RAID 0, RAID 5, RAID 5-0, RAID 6, parity de-clustered RAID, etc.). Extra translation layers can also support RAID tiering and various RAID tier-based configurations. Extra translation layers, as described herein, can also support so-called “thin provisioning,” (e.g., variable, dynamic layer sizing) various forms of encryption, and/or zero stripe compression. According to various embodiments, a data translation layer can be configured to allow logical unit number thin provisioning by including a sparse data translation layer having a sparseness, where the sparseness is aligned to a data granularity of the data translation later.

As described herein, the various translation layers can also support LUN expand, LUN shrink, unmap (e.g., at stripe alignment, with a single parity physical block number expand/shrink/unmap can be implemented with one or more data physical block number (e.g., not necessarily at the granularity of a particular stripe).

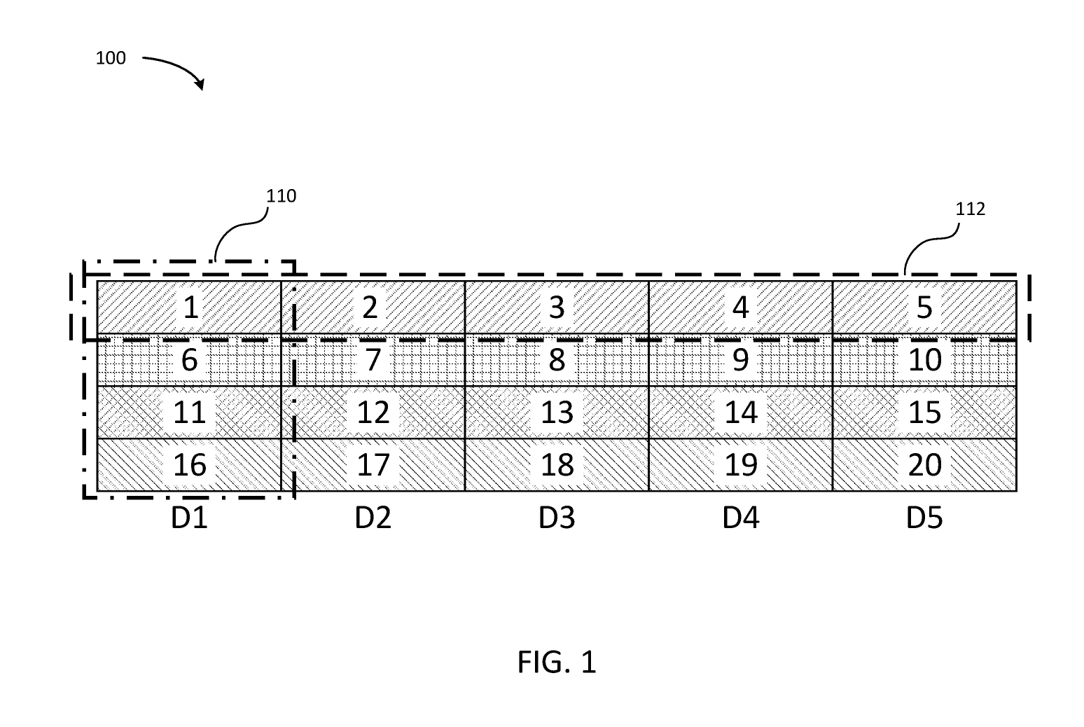

FIG. 1 is a block diagram of a storage system 100 having five drives and the drives having four stripes, according to various embodiments. Storage system 100 can be an n-way RAID, where n can be any number of drives and not limited to the example given.

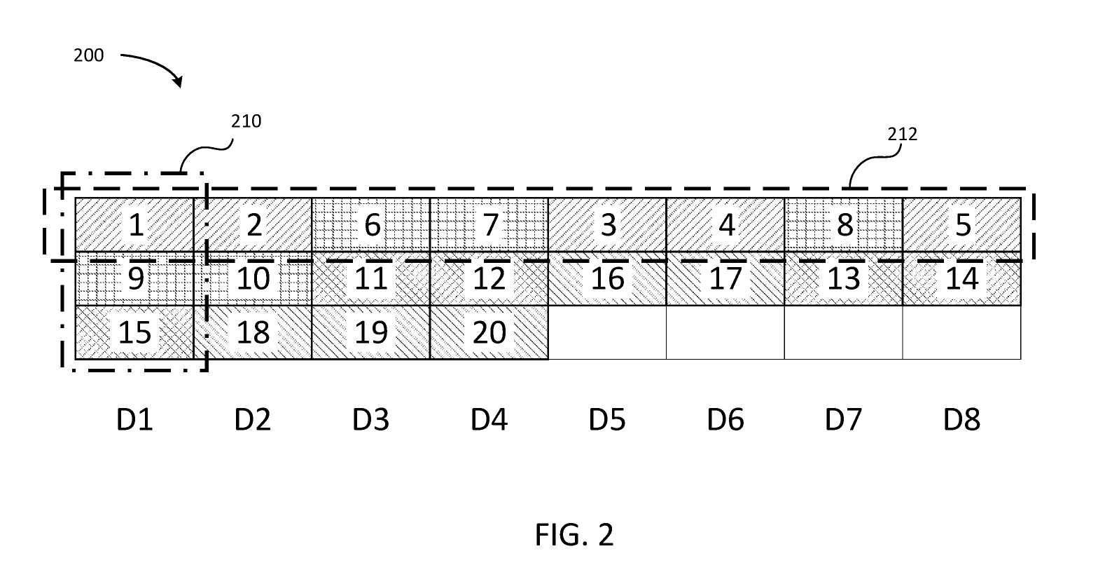

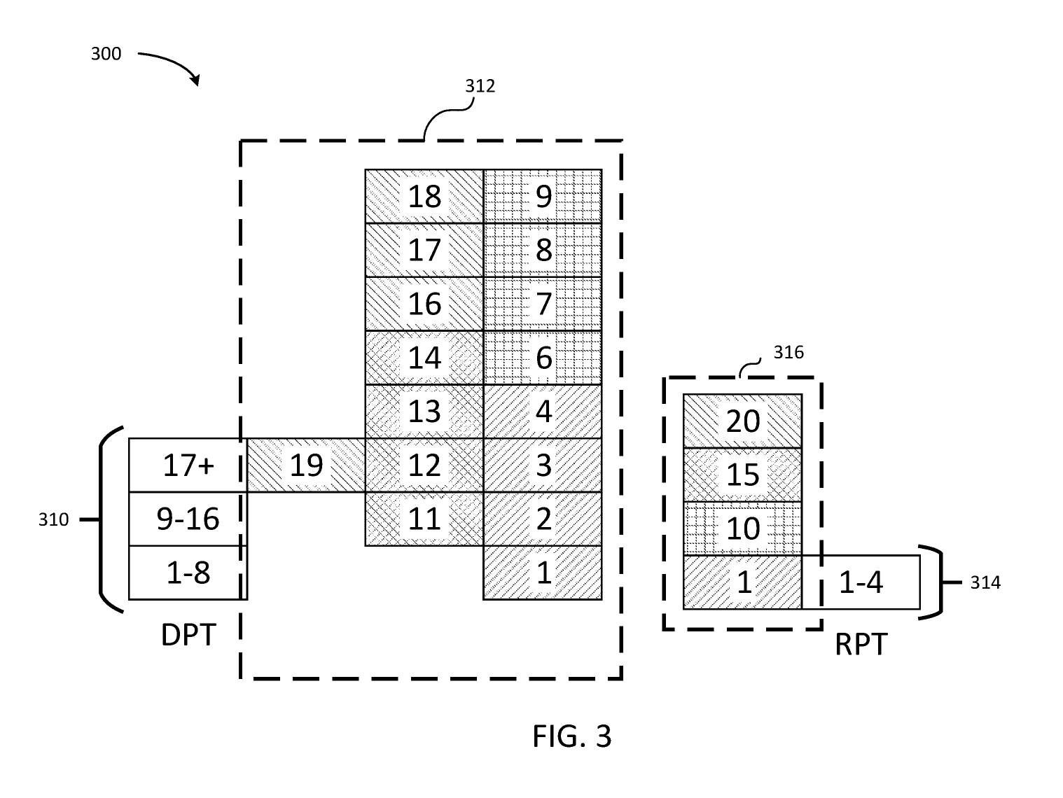

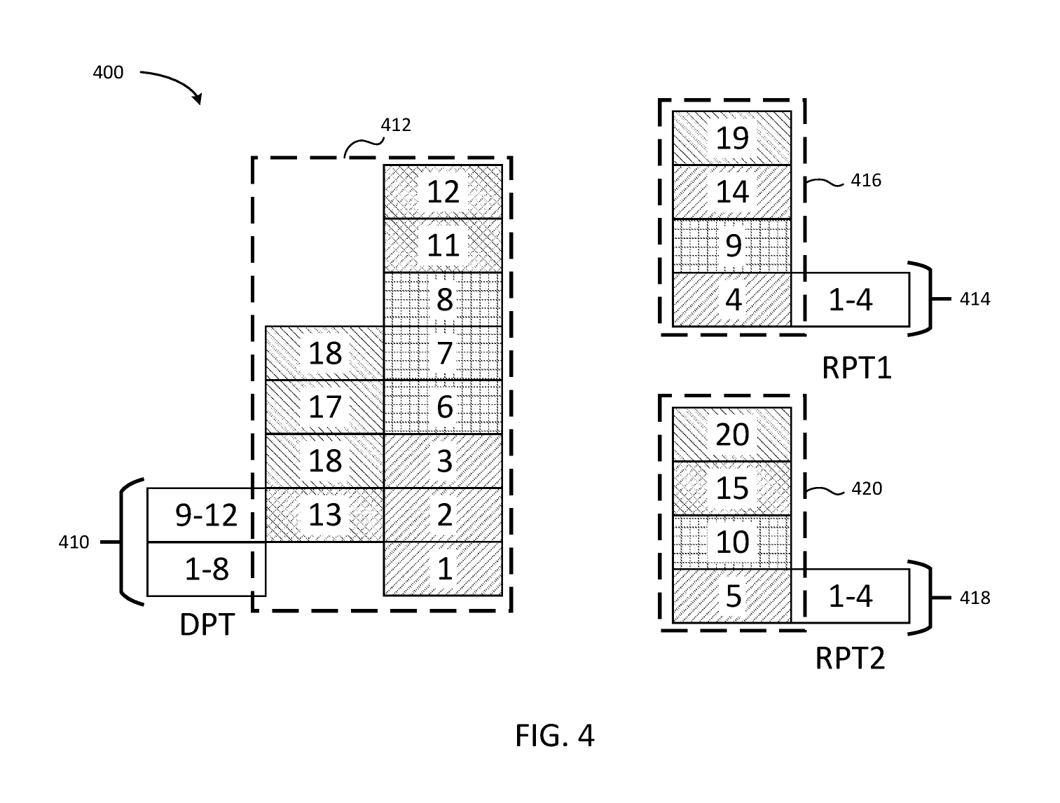

According to various embodiments, FIG. 1 can represent either RAID 5 or RAID 6. The corresponding mapping tables would be as in FIG. 3 for RAID 5 and FIG. 4 for RAID 6. For RAID 0, the RPT table would not typically be not available. FIG. 2 represents a parity de-clustered RAID and FIGS. 3/4 represent the mapping table for the parity de-clustered RAID type if it is built on either RAID 5 or RAID 6 respectively.

As shown, storage system 100 includes five drives D1-D5, and can be provisioned as either four stripes in a RAID 5, 4+1 configuration or a RAID 6, 3+2 double-redundant configuration. As shown, with five physical drives with four stripes, each stripe can be said to have a stripe (or data) granularity of 5.

Storage system 100, as shown, is storing 20 LBAs, numbered 1-20. Example drive D1 includes LBAs 110, including LBA 1, 6, 11, and 16, as shown. Four stripes are shown, including stripe 112, which includes LBAs 1, 2, 3, 4, and 5. Drives D2-D5 includes LBAs in LBA columns, as shown, similar to LBA column 110.

Storage system 100 is representation of a striped RAID (RAID 0, RAID 5, and/or RAID 6) with distinguishing features including a number of parity LBAs in each stripe and how they are placed across different contiguous stripes. RAID 0 of 5 drives would have no parity LBA and 5 data LBAs, RAIDS has one parity LBA and 4 data LBAs and RAID 6 had 2 parity LBAs and 3 data LBAs in a single stripe.

FIG. 2 is a block diagram of a storage system 200 having eight drives having four stripes, according to various embodiments.

In more detail, storage system 200 represents a parity de-clustered RAID configuration, where the underlying stripes are still either RAID 5 or RAID 6, but the LBAs themselves are dispersed across all the physical drives. As shown, any five drives out of the eight drives can constitute a stripe, but the LBAs themselves do not fall at the same offset in any particular physical drive. Therefore, a parity de-clustered RAID using RAID 5 configuration still has four data LBAs and one parity LBA totaling five LBAs in a stripe. A parity de-clustered RAID using a RAID 6 configuration still has three data LBAs and two parity LBAs in a five LBAs stripe. The five LBAs of a stripe can be selected randomly across all the drives.

As shown, storage system 200 includes eight drives D1-D8, and can be provisioned as either four stripes in a de-clustered RAID 5, 4+1 configuration or a de-clustered RAID 6, 3+2 double-redundant configuration.

Storage system 200, as shown, is storing 20 LBAs, numbered 1-20. Example drive D1 includes LBAs, including LBA 1, 9, and 15, as shown in LBA column 210. Four stripes are shown, spread across four rows (e.g., first row 212). First row 212, as shown, includes LBAs 1, 2, 6, 7, 3, 4, 8, and 5, but first row 212 does not represent a single stripe. Drives D2-D8 include LBAs illustrated in LBA columns, similar to LBA column 210, which may represent which LBAs are to be stored on a single drive according to various RAID schemes and/or striping configurations. FIG. 2 shows 20 LBAs with eight drives combined to form four unique stripes with five LBAs per stripe. A first stripe includes LBAs 1, 2, 3, 4, and 5. A second stripe includes LBAs 6, 7, 8, 9, and 10. A third stripe includes LBAs 11, 12, 13, 14, and 15. Finally, a fourth stripe includes LBAs 16, 17, 18, 19, and 20. Therefore, four stripes of five LBAs that could internally be represented as a RAID 5 or RAID 6 are shown.

As shown, drives D5-D8 (and associated LBA columns) include two LBAs, compared to three LBAs for drives D1-D4. Various factors, such as page size, file size, and other factors can dictate a total number of LBAs (blocks).

FIG. 3 is an example translation table 300 for FIG. 1 and FIG. 2 provisioned with RAID 5 data protection, according to various embodiments.

Mapping table 300, as shown, represents an example 4+1 RAID 5 where each RAID 5 stripe is at virtual block stripe or data granularity. Each RAID 5 has four data LBAs and one parity LBA. One objective of RAID in an I/O path is to convert the host LBA, number of blocks (host I/O) into RAID stripes, and perform RAID data management and/or logic over it before sending it to associated physical drives. Here, a DPT 310 is used to map a host I/O to data LBAs of a RAID stripe. DPT 310 includes translation data for LBAs 312 containing data to be translated, according to an embodiment. Corresponding redundant page table 314 includes LBAs 316, which correspond to parity data as shown in FIGS. 1 and 2. As shown, DPT 310 includes three segments, including a DPT segment for LBAs 1-8, a DPT segment for LBAs 9-16, and a DPT segments for LBAs 17 and up.

An RPT 314 can be used to convert host I/O operations into parity LBA of a RAID stripe. Therefore, by using the DPT 310 and RPT 314, a host I/O can be converted to a complete RAID stripe. The data LBAs in DPT 310 can be arranged in such a way that all the data LBAs in all the stripes are arranged one after other, and so that host LBA indexed into DPT would directly give the details of all the data LBAs in a particular RAID stripe onto which the host I/O spans. Similarly, the corresponding parity LBA is received from the RPT 314. In various embodiments, the RPT 314 can be arranged in such a way that all the parity LBAs for each of the RAID stripes are looked up using the RPT 314 table.

A virtual block number can be defined as a host LBA divided by a virtual block size. Virtual block number stripe start (VBNSS) can be defined as a virtual block number divided by data stripe size multiplied by data stripe size incremented by one (+1). Virtual block number parity (VBNP) can be defined as virtual block number divided by data stripe size. A complete stripe would be VBNSS, virtual block number stripe start incremented by one (+1), and so forth until VBNSS plus data stripe size —1 and VBNP. All the data LBAs starting from VBNSS can be indexed into DPT 310 to get details on the corresponding physical block numbers and parity LBA VBNP is indexed into RPT 314 to get details on the corresponding physical block.

For the purposes of the DPT 310 and/or RPT 314, LBA numbering may not correspond to the LBA numbering shown on the individual LBAs.

FIG. 4 is a translation table 400 for FIG. 1 and FIG. 2 provisioned with RAID 6 data protection, according to various embodiments.

Data page table (DPT) 410 includes translation data for LBAs 412 containing data to be translated, according to an embodiment. Corresponding redundant page tables 414 and 418 include LBAs 416 and 420, respectively, which correspond to parity data as shown in FIGS. 1 and 2.

Similar to RAID 5 (as shown in FIG. 3), for RAID 6 there are two parity LBAs. For each of the parity LBAs a redundant parity table can be added to get details of the parity LBA. VBSS, VBNP can then be calculated as in RAID 5. VBNP can be indexed into both RPT1 and RPT2 to get the two parity LBAs of a RAID 6 stripe. As shown, DPT, RPT1 414 and RPT2 418 are arranged in such a way that each RAID 6 stripe containing data LBAs are placed on DPT 410, the two parity LBAs are placed on RPT1 414 and RPT2 418, one each. By having this arrangement a host I/O can be broken down into its constituent RAID stripes with all the data and parity LBAs.

For the purposes of the DPT 410, RPT1 414, and/or RPT2 418, LBA numbering may not correspond to the LBA numbering shown on the individual LBAs.

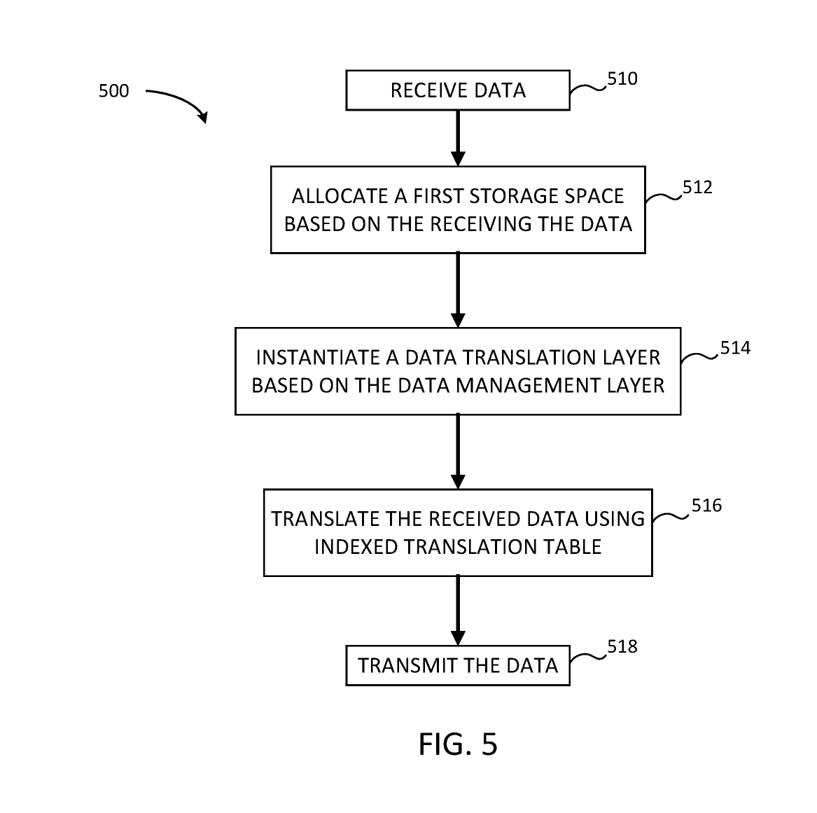

FIG. 5 is a flowchart 500 for a method according to the present invention, according to various embodiments.

Flowchart 500 begins by receiving data at operation 510. Following operation 510, a first storage space on a first storage medium (e.g., a storage system, as used herein) can be allocated at a data management layer based on received data at operation 510. Next, an indexed translation table can be instantiated based on the data management layer at operation 514, where the translation table is configured to communicate with a data protection layer (DPL).

Following operation 514, the received data from the first storage space on the first storage medium can be translated using the indexed translation table to a second storage space on the second storage medium. At operation 518, following operation 516, the data can be transmitted. At operation 514 the data can be transmitted to any system, component, program, etc., as applicable. Each layer either DML or DPL can use the translation table and can employ usual relevant algorithms, as shown.

FIG. 6 is a block schematic diagram of a computer system 600, according to embodiments of the present disclosure.

Computer system 600, as shown, is configured with an interface 616 to enable controller 610 to receive a request to manage and protect data, as described in particular with regard to FIGS. 1-5. An input 618 may be received at interface 616. In embodiments, the interface 616 can enable controller 610 to receive, or otherwise access, the input 618 via, for example, a network (e.g., an intranet, or a public network such as the Internet), or a storage medium, such as a disk drive internal or connected to controller 610. The interface can be configured for human input or other input devices, such as described later in regard to components of controller 610. It would be apparent to one of skill in the art that the interface can be any of a variety of interface types or mechanisms suitable for a computer, or a program operating in a computer, to receive or otherwise access or receive a source input or file.

Processors 612, 614 included in controller 610 are connected by a memory interface 620 to memory device or module 630. In embodiments, the memory 630 can be a cache memory, a main memory, a flash memory, or a combination of these or other varieties of electronic devices capable of storing information and, optionally, making the information, or locations storing the information within the memory 630, accessible to a processor. Memory 630 can be formed of a single electronic (or, in some embodiments, other technologies such as optical) module or can be formed of a plurality of memory devices. Memory 630, or a memory device (e.g., an electronic packaging of a portion of a memory), can be, for example, one or more silicon dies or chips, or can be a multi-chip module package. Embodiments can organize a memory as a sequence of bit, octets (bytes), words (e.g., a plurality of contiguous or consecutive bytes), or pages (e.g., a plurality of contiguous or consecutive bytes or words).

In embodiments, computer 600 can include a plurality of memory devices. A memory interface, such as 620, between a one or more processors and one or more memory devices can be, for example, a memory bus common to one or more processors and one or more memory devices. In some embodiments, a memory interface, such as 620, between a processor (e.g., 612, 614) and a memory 630 can be point to point connection between the processor and the memory, and each processor in the computer 600 can have a point-to-point connection to each of one or more of the memory devices. In other embodiments, a processor (for example, 612) can be connected to a memory (e.g., memory 630) by means of a connection (not shown) to another processor (e.g., 614) connected to the memory (e.g., 620 from processor 614 to memory 630).

Computer 600 can include an input/output (I/O) bridge 650, which can be connected to a memory interface 620, or to processors 612, 614. An I/O bridge 650 can interface the processors 612, 614 and/or memory devices 630 of the computer 600 (or, other I/O devices) to I/O devices 660 connected to the bridge 620. For example, controller 610 includes I/O bridge 650 interfacing memory interface 620 to I/O devices, such as I/O device 660. In some embodiments, an I/O bridge can connect directly to a processor or a memory, or can be a component included in a processor or a memory. An I/O bridge 650 can be, for example, a peripheral component interconnect express (PCI-Express) or other I/O bus bridge, or can be an I/O adapter.

An I/O bridge 650 can connect to I/O devices 660 by means of an I/O interface, or I/O bus, such as I/O bus 622 of controller 610. For example, I/O bus 622 can be a PCI-Express or other I/O bus. I/O devices 660 can be any of a variety of peripheral I/O devices or I/O adapters connecting to peripheral I/O devices. For example, I/O device 660 can be a graphics card, keyboard or other input device, a hard disk drive (HDD), solid-state drive (SSD) or other storage device, a network interface card (NIC), etc. I/O devices 660 can include an I/O adapter, such as a PCI-Express adapter, that connects components (e.g., processors or memory devices) of the computer 600 to various I/O devices 660 (e.g., disk drives, Ethernet networks, video displays, keyboards, mice, styli, touchscreens, etc.).

Computer 600 can include instructions executable by one or more of the processors 612, 614 (or, processing elements, such as threads of a processor). The instructions can be a component of one or more programs. The programs, or the instructions, can be stored in, and/or utilize, one or more memory devices of computer 600. As illustrated in the example of FIG. 6, controller 610 includes a plurality of programs or modules, such as translation module 606, striping module 607, LBA module 609, and RAID module 605. A program can be, for example, an application program, an operating system (OS) or a function of an OS, or a utility or built-in function of the computer 600. A program can be a hypervisor, and the hypervisor can, for example, manage sharing resources of the computer 600 (e.g., a processor or regions of a memory, or access to an I/O device) among a plurality of programs or OSes.

Programs can be “stand-alone” programs that execute on processors and use memory within the computer 600 directly, without requiring another program to control their execution or their use of resources of the computer 600. For example, controller 610 includes (optionally) stand-alone programs in translation module 606, striping module 607, LBA module 609, and RAID module 605. A stand-alone program can perform particular functions within the computer 600, such as controlling, or interfacing (e.g., access by other programs) an I/O interface or I/O device. A stand-alone program can, for example, manage the operation, or access to, a memory (e.g., memory 630). A basic I/O subsystem (BIOS), or a computer boot program (e.g., a program that can load and initiate execution of other programs) can be a standalone program.

Controller 610 within computer 600 can include one or more OS 602, and an OS 602 can control the execution of other programs such as, for example, to start or stop a program, or to manage resources of the computer 600 used by a program. For example, controller 610 includes OS 602, which can include, or manage execution of, one or more programs, such as OS 602 including (or, managing) Disk layer module 608, and storage space allocation module 604. In some embodiments, an OS 602 can function as a hypervisor.

A program can be embodied as firmware (e.g., BIOS in a desktop computer, or a hypervisor) and the firmware can execute on one or more processors and, optionally, can use memory, included in the computer 600. Firmware can be stored in a memory (e.g., a flash memory) of the computer 600. For example, controller 610 includes firmware 640 stored in memory 630. In other embodiments, firmware can be embodied as instructions (e.g., comprising a computer program product) on a storage medium (e.g., a CD-ROM, DVD-ROM, flash memory, or disk drive), and the computer 600 can access the instructions from the storage medium.

In embodiments of the present disclosure, computer 600 can include instructions for data management and protection. Controller 610 includes, for example, translation module 606, striping module 607, LBA module 609, and RAID module 605, which can operate to stripe, translate, protect, and otherwise manage various data blocks based on need or request.

The example computer system 600 and controller 610 are not intended to limiting to embodiments. In embodiments, computer system 600 can include a plurality of processors, interfaces, and inputs and can include other elements or components, such as networks, network routers or gateways, storage systems, server computers, virtual computers or virtual computing and/or I/O devices, cloud-computing environments, and so forth. It would be evident to one of skill in the art to include a variety of computing devices interconnected in a variety of manners in a computer system embodying aspects and features of the disclosure.

In embodiments, controller 610 can be, for example, a computing device having a processor (e.g., 612) capable of executing computing instructions and, optionally, a memory 630 in communication with the processor. For example, controller 610 can be a desktop or laptop computer; a tablet computer, mobile computing device, personal digital assistant (PDA), or cellular phone; or, a server computer, a high-performance computer (HPC), or a super computer. Controller 610 can be, for example, a computing device incorporated into a wearable apparatus (e.g., an article of clothing, a wristwatch, or eyeglasses), an appliance (e.g., a refrigerator, or a lighting control), a mechanical device, or (for example) a motorized vehicle. It would be apparent to one skilled in the art that a computer embodying aspects and features of the disclosure can be any of a variety of computing devices having processors and, optionally, memory devices, and/or programs.

It is understood that numerous variations of data management and protection using a common translation layer could be made while maintaining the overall inventive design of various components thereof and remaining within the scope of the disclosure. Numerous alternate design or element features have been mentioned above.

As used herein, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

Although certain features are described generally herein relative to particular embodiments of the invention, it is understood that the features are interchangeable between embodiments to arrive at data management using a common translation layer for data translation. It is further understood that certain embodiments discussed above include performing data management using a common translation layer using both DML and DPL, as described herein.

Reference is made herein to the accompanying drawings that form a part hereof and in which are shown by way of illustration at least one specific embodiment. The detailed description provides additional specific embodiments. It is to be understood that other embodiments are contemplated and may be made without departing from the scope or spirit of the present disclosure. The detailed description, therefore, is not to be taken in a limiting sense. While the present disclosure is not so limited, an appreciation of various aspects of the invention will be gained through a discussion of the examples provided.

What is claimed is:

1. A method of managing data in a redundant array of independent disks (RAID) system, comprising:
receiving data;
allocating a first storage space on a first storage medium at a data management layer based on data received;
instantiating a data translation layer based on the data management layer, the data translation layer configured to communicate with a data protection layer;
translating the received data from the first storage space on the first storage medium using the data translation layer to a second storage space on a second storage medium; and
transmitting the data.

2. The method of claim 1, wherein the data translation layer is configured to communicate the data management layer at a first data granularity, and wherein the data translation layer is configured to communicate with the data protection layer at a second data granularity.

3. The method of claim 1, wherein the data management layer uses a complete stripe for data storage on the data translation layer.

4. The method of claim 1, wherein the data protection layer uses a partial stripe for data storage on the data translation layer.

5. The method of claim 1, wherein the data translation layer is configured to utilize tiering at a stripe level, such that user data on a stripe can be swapped with a stripe from a lower or a higher RAID tier.

6. The method of claim 1, wherein the data translation layer is configured to use at least a RAID 5 system including a single parity check.

7. The method of claim 1, wherein the data translation layer is configured to use at least a RAID 6 system including a double parity check.

8. The method of claim 1, wherein the data translation layer is configured to expand or shrink at a stripe granularity of the data translation layer by adding or deleting, respectively, multiples of stripes to or from the data translation layer.

9. A system, comprising:
a hardware processor operatively connected to a memory and the data management system configured to perform steps including:
receiving data;
allocating a first storage space on a first storage medium at a data management layer based on data received;
instantiating a data translation layer based on the data management layer, the data translation layer configured to communicate with a data protection layer; and
translating the received data from the first storage space on the first storage medium using the data translation layer to a second storage space on a second storage medium.

10. The system of claim 9, wherein the data translation layer is configured to communicate the data management layer at a first data granularity, and wherein the data translation layer is configured to communicate with the data protection layer at a second data granularity.

11. The system of claim 9, wherein the data translation layer includes an indexed translation table.

12. The system of claim 9, wherein the data translation layer is generic and is configured to work for at least one striped RAID type selected from the group consisting of: RAID 0, RAID 4, RAID 5, RAID 5-0, RAID 6, and parity de-clustered RAID.

13. The system of claim 9, wherein the data translation layer is configured to expand or shrink at a data granularity of the data translation layer by adding or deleting, respectively, multiples of stripes to or from the data translation layer.

14. A computer program product for managing data in a redundant array of independent disks (RAID) system, comprising: a computer-readable storage device having a computer-readable program stored therein, wherein the computer-readable program, when executed on a computing device improves the computing device and causes the computing device to:
receive data;
allocate a first storage space on a first storage medium at a data management layer based on data received;
instantiate a data translation layer based on the data management layer, the data translation layer configured to communicate with a data protection layer;
translate the received data from the first storage space on the first storage medium using the data translation layer to a second storage space on a second storage medium; and
transmit the data.

15. The computer program product of claim 14, wherein the data translation layer is configured to communicate the data management layer at a first data granularity, and wherein the data translation layer is configured to communicate with the data protection layer at a second data granularity.

16. The computer program product of claim 14, wherein the data management layer uses a complete stripe for data storage on the data translation layer.

17. The computer program product of claim 14, wherein the data protection layer uses a partial stripe for data storage on the data translation layer.

18. The computer program product of claim 14, wherein the data translation layer is configured to expand or shrink at a data granularity of the data translation layer by adding or deleting, respectively, multiples of stripes to or from the data translation layer.

19. The computer program product of claim 14, wherein the data translation layer includes user logical unit number space.

20. The computer program product of claim 14, wherein the data translation layer is configured to allow logical unit number thin provisioning by including a sparse data translation layer having a sparseness, wherein the sparseness is aligned to a data granularity of the data translation later.
